(19) United States
(12) Patent Application Publication
(10) Pub. No.: US 2024/0391787 A1
(43) Pub. Date: Nov. 28, 2024

(54) PROCESS FOR OBTAINING HIGH PURITY LITHIUM FROM AN AQUEOUS LITHIUM SALT-CONTAINING SOLUTION

(71) Applicant: Koch Technology Solutions, LLC, Wichita, KS (US)

(72) Inventors: Constantine Collias, Toronto (CA); Jason Alan Bootsma, Wichita, KS (US); Daniel Travis Shay, Chadds Ford, PA (US); Timothy Jude Campbell, Ridley Park, PA (US)

(21) Appl. No.: 18/664,346

(22) Filed: May 15, 2024

Related U.S. Application Data
(60) Provisional application No. 63/469,059, filed on May 26, 2023.

(51) Int. Cl. C01D 15/04; B01D 15/42; B01D 61/02

(52) U.S. Cl. CPC C01D 15/04; B01D 15/424; B01D 61/025

(57) ABSTRACT

There is disclosed a process for selectively purifying a lithium chloride product stream from an aqueous lithium salt-containing solution, the process comprising the steps of: introducing the aqueous lithium salt-containing solution to one or more columns filled with a lithium selective sorbent; flowing the aqueous lithium salt-containing solution through the one or more columns to adsorb lithium chloride from the aqueous lithium salt-containing solution onto a sorbent and form a sorbent with a greater lithium chloride content than the sorbent prior to introducing the solution; flowing a desorbent fluid once-through the at least one or more columns to desorb lithium chloride from the sorbent into an eluate stream, wherein the desorbent fluid is flowed in a co-current direction with respect to the direction of flow of the aqueous lithium salt-containing solution, and recovering a lithium chloride product stream from the eluate stream, wherein the eluate stream has a Li:TDS ratio of 0.08 or more.

### RELATED APPLICATION

This application claims priority to U.S. Provisional Patent Application No. 63/469,059 filed May 26, 2023, which is incorporated herein by reference in its entirety.

### TECHNICAL FIELD

The disclosed process relates to achieving high purity lithium in a lithium chloride product stream from an aqueous lithium salt-containing solution.

### BACKGROUND

The global lithium market is expanding and is expected to continue expanding over forthcoming years. Electrification of vehicles will command a significant volume of lithium-ion batteries, driving this anticipated growth in the global lithium market. As the 33^{rd} most abundant element, lithium (Li) is present in the earth's crust at 0.002-0.006 wt % and is distributed widely in trace amounts in rocks, soil and surface water, groundwater, and sea water. Hard rock and evaporative pond mining are the two predominant means for sourcing lithium salts. However, these methods are expensive, requiring large footprints which may scar the land and create significant wastewater leaching environmental issues.

Processes for selective adsorption of lithium salts from aqueous sources are being developed and show promise for reducing the cost and environmental impact of lithium mining. Such processes are called direct lithium extraction (“DLE”) methods. The main stages of a DLE process include extraction of the lithium from an aqueous lithium salt-containing solution using an adsorbent material and subsequent elution of the lithium from this adsorbent material with an eluent to produce an eluate, followed by further concentration and purification steps. This eluate is typically at a higher lithium concentration and lower impurity level than the original aqueous lithium salt-containing solution. However, there is a need to further increase the purity of lithium in a lithium chloride product stream.

### SUMMARY

In a direct lithium extraction (DLE) process, selective adsorption of lithium salts from aqueous sources is typically currently conducted by flowing an aqueous lithium salt-containing solution through a packed bed of adsorbent material to allow lithium chloride in the aqueous lithium salt-containing solution to adsorb to the adsorbent material, or sorbent, and then subsequently washing (or eluting) the lithium chloride from the sorbent with an eluent to produce an eluate, followed by further concentration and purification steps. Although this eluate is typically at a higher lithium concentration and lower impurity level than the original aqueous lithium salt-containing solution, there remains a need to increase the purity of lithium in a lithium chloride product stream. An eluate with a higher purity of lithium chloride contains a lower level of impurities or contaminants. Such impurities or contaminants contribute to the Total Dissolved Solids (TDS). A lower level of contaminants and resulting lower Total Dissolved Solids allows a greater level of downstream reverse osmosis (RO) concentration of the eluate and therefore the lithium in the resulting concentrate.

Aspects herein provide solutions to achieve high levels of lithium purity in eluates with a lithium to Total Dissolved Solids (TDS) ratio (Li:TDS) of 0.08 or more.

In some aspects, the techniques described herein relate to a process for selectively purifying a lithium chloride product stream from an aqueous lithium salt-containing solution, the process comprising the steps of:
a. introducing the aqueous lithium salt-containing solution to one or more columns filled with a lithium selective sorbent;
b. flowing the aqueous lithium salt-containing solution through the one or more columns to adsorb lithium chloride from the aqueous lithium salt-containing solution onto a sorbent and form a sorbent with a greater lithium chloride content than the sorbent prior to introducing the solution;
c. flowing a desorbent fluid once-through the at least one or more columns to desorb lithium chloride from the sorbent into an eluate stream, wherein the desorbent fluid is flowed in a co-current direction with respect to the direction of flow of the aqueous lithium salt-containing solution, and
d. recovering a lithium chloride product stream from the eluate stream, wherein the eluate stream has a Li:TDSratio of 0.08 or more.

In an embodiment of the process, the aqueous lithium salt-containing solution is a naturally-occurring solution, a synthetic solution or a mixture thereof.

In an embodiment of the process, the aqueous lithium salt-containing solution is subject to a pre-treatment step of mechanical pre-treatment, temperature adjustment, chemical pre-treatment or pH adjustment.

In an embodiment of the process, the lithium selective sorbent is an ion sieve sorbent, a lithium-metal oxide sorbent, a mixed metal oxide sorbent, an alkali or alkali earth metal/alumina matrix, transition metal/alumina matrix or a molecular sieve sorbent.

In an embodiment of the process, the one or more columns are packed-bed columns.

In an embodiment of the process, the desorbent fluid is water, pH adjusted water or a polar organic solvent.

In an embodiment of the process, the desorbent fluid is derived from a process operation or is a recycled process stream.

In an embodiment of the process, there may be a step between the step of flowing the aqueous lithium salt-containing solution through the one or more columns to adsorb lithium chloride from the aqueous lithium salt-containing solution onto a sorbent and form a sorbent with a greater lithium chloride content than the sorbent prior to introducing the solution (step b)) and the step of flowing a desorbent fluid once-through the at least one or more columns to desorb lithium chloride from the sorbent into an eluate stream (step c)) of addition of a conductive metal salt solution.

In an embodiment of the process, the conductive metal salt solution is an alkali metal salt solution.

In an embodiment of the process, the alkali metal salt solution is any mono-valent water-soluble salt.

In an embodiment of the process, there may be an additional step (step e)) following the step of recovering a lithium chloride product stream from the eluate stream, wherein the eluate stream has a Li:TDS ratio of 0.08 or more (step d)) of concentrating the lithium chloride product stream using reverse osmosis, solvent extraction, evaporation, freeze crystallization or a combination.

In an embodiment of the process, the reverse osmosis is any of seawater reverse osmosis, brackish water reverse osmosis, osmotically assisted reverse osmosis or ultra-high pressure reverse osmosis.

In an embodiment of the process, the process steps a) to e) may be repeated.

In an embodiment of the process, the flowing of the aqueous lithium salt-containing solution in step b) is carried out at a variable velocity within the range of 4 LPM/M² to 800 LPM/M² column cross sectional area, and preferably 80 to 400 LPM/M² column cross sectional area.

In an embodiment of the process, the flowing of the desorbent fluid in step c) is carried out at a variable velocity within the range of 4 LPM/M² to 800 LPM/M² column cross sectional area, and preferably 80 to 400 LPM/M² column cross sectional area.

Other features and aspects of the disclosure are set forth in greater detail below.

### BRIEF DESCRIPTION OF THE DRAWINGS

The drawings illustrate generally, by way of example, but not by way of limitation, various aspects of the present invention.

FIG. 1 is a flow chart of a method for producing high-purity lithium chloride according to the present disclosure.

FIG. 2A is a graph showing a typical adsorption profile of cations onto a sorbent column.

FIG. 2B is a graph showing a typical elution profile of cations from a sorbent column.

FIG. 3 is a graph showing loading rates onto a sorbent column with constant velocity and variable velocity loading.

FIG. 4A is a graph showing elution profile from a sorbent column with constant velocity elution.

FIG. 4B is a graph showing elution profile from a sorbent column with variable velocity elution.

FIG. 5 is an elution profile showing co-current and counter-current elution.

FIG. 6 is a flow chart of a method for producing high-purity lithium chloride according to an embodiment of the present disclosure.

FIG. 7A is a graph showing the separation of lithium cations from other non-lithium cations in a standard elution.

FIG. 7B is a graph showing the increased separation efficiency of lithium cations from other non-lithium cations with a conductive metal salt solution step pre-elution.

### DETAILED DESCRIPTION

Reference will now be made in detail to certain aspects of the disclosed subject matter, examples of which are illustrated in part in the accompanying drawings. The following descriptions and examples are merely illustrative of the exemplary embodiments, and do not limit the scope of the invention.

Unless otherwise defined, all scientific and technical terms used herein are intended to have the same meaning as would be understood by a person of skill in the art to which this disclosure relates. The materials, methods and examples are illustrative only and not intended to be limiting. The word “comprise” and variations such as “comprises” or “comprising” are understood to mean the inclusion of a stated integer or group of integers but not the exclusion of any other integer or group of integers.

Unless specifically stated otherwise or obvious from the context used herein, the terms “about” and “approximately” are understood as lying within a range of normal tolerances in the art, for example within two standard deviations of the mean. “About” and “approximately” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

A clear distinction between the terms “concentration” and “purity” is important. Lithium concentration is a measure of the lithium per unit of volume (for example, mg/L) or lithium per unit of mass (ppm). Concentration does not differentiate between the other components in the solution. In contrast, lithium purity is a measure of the lithium against all components other than water or other volatile solvents. Purity is concerned with the other non-volatile components in the solution. Examples of these components are sodium, calcium, boron, chloride, sulfates, and carbonates. The non-volatile components are often measured or expressed collectively as Total Dissolved Solids (TDS).

The disclosure is directed to a process for selectively purifying a lithium chloride product stream from an aqueous lithium salt-containing solution wherein the eluate stream has a Li:TDS ratio of 0.08 or more. Such a ratio can be obtained by using a portion of the eluate stream that has a sub-optimum concentration of lithium (i.e. a portion of the eluate stream which does not have the highest lithium concentration) which concomitantly means that there is also a lower level of TDS in the eluate. It is known that the process as disclosed herein can improve downstream concentration steps, because the eluate stream with a Li:TDS ratio of 0.08 or more has a lower level of contaminants and lower TDS, allowing reverse osmosis (RO) concentration of the eluate to be more effective, giving a higher concentration factor and a more concentrated lithium chloride product stream. Therefore, the process as disclosed herein improves overall process efficiency, thereby reducing costs. It is preferable to improve the purity of lithium in downstream reverse osmosis processes rather than using chemical softening methods to remove unwanted contaminants.

Typically, elution methods use a high degree of loading on the sorbent in the column and subsequently utilize the portion of the eluate stream with the highest concentrations of lithium. The logic in doing so is that by starting with the highest concentration of lithium in the eluate, the final concentration of lithium after downstream concentration steps will still be high. However, it is known that recovery of high concentration levels of lithium in eluates is associated with high contaminant concentration levels, in particular sodium concentrations. High sodium concentrations negatively affect reverse osmosis processes because sodium substantially contributes to the osmotic pressure, giving a lower concentration factor. Therefore, the fraction of the eluate stream with the highest levels of lithium (which may be known as the lithium peak area (and even areas either side of the lithium peak area)) will also be rich in contaminants, in particular sodium, and will be subject to a less-efficient downstream concentration step. It is therefore desirable to use an eluate stream with a high as possible ratio between lithium and the undesirable contaminants, and this is provided by the present disclosure.

The use of reverse osmosis membrane technology on the eluate lowers the energy use of the process because it reduces or eliminates the need for costly thermal evaporation concentration. A lower level of TDS in the eluate enables even more effective reverse osmosis, and therefore higher concentration. For example, a sea water reverse osmosis (SWRO) can achieve a concentrate of 80,000 mg/L of TDS, which means a lower initial level of concentration of contaminants contributing to TDS allows greater concentration of the eluate to occur. As an example, with a lower purity eluate having a Li:TDS ratio of 0.027, the maximum concentration factor possible with a SWRO is 3.9. However, increasing the purity of the eluate to a Li:TDS ratio of 0.04 allows a concentration factor of 6.9 to be achieved. Further, increasing the Li:TDS ratio to 0.98 allows a 10× concentration factor to be achieved.

As shown in Table 1 below, lines 7, 8, 9 and 10 represent the volume fractions of the eluate having a Li:TDS ratio of 0.08 or more. Table 1 shows that although the lithium is not at the highest concentration in lines 7 to 10, the Total Dissolved Solids (TDS) concentration is much lower in the fractions represented by lines 7 to 10 than in lines 1 to 6. The present disclosure therefore places a greater emphasis on rejection, and lower concentration levels, of TDS rather than focusing on obtaining a high concentration of lithium in the eluate, because this will enable the downstream reverse osmosis to be as effective as possible, ultimately yielding a high concentration of lithium chloride in the final product. It is preferable to improve the purity of lithium in downstream reverse osmosis processes rather than using means such as chemical softening to remove unwanted cations.

TABLE 1

| Fraction no. | Lithium (mg/L) | TDS (mg/L) | Li:TDS ratio |
|---|---|---|---|
| 1 | 800 | 40,000 | 0.02 |
| 2 | 800 | 26,667 | 0.03 |
| 3 | 600 | 15,000 | 0.04 |
| 4 | 600 | 12,000 | 0.05 |
| 5 | 500 | 8,333 | 0.06 |
| 6 | 500 | 7,143 | 0.07 |
| 7 | 400 | 5,000 | 0.08 |
| 8 | 400 | 4,444 | 0.09 |
| 9 | 300 | 3000 | 0.10 |
| 10 | 300 | 2,727 | 0.11 |

Further still, capitalizing on this principle, it is also known in the prior art to take the fraction of the eluate stream with the highest concentration levels of lithium and recycle this fraction to the sorbent. This recycling step allows for an increase in ratio between lithium and TDS while maintaining overall lithium recovery. However, this disadvantageously requires more time and resources to include an additional recycle step.

The process as disclosed herein for selectively purifying a lithium chloride product stream from an aqueous lithium salt-containing solution wherein the eluate stream has a Li:TDS ratio of 0.08 or more therefore not only improves overall process efficiency by virtue of allowing downstream reverse osmosis processes to be more effective but also reduces the time required for a set number of loading and elution cycles by eliminating recycle steps. In an embodiment, the eluate stream in the process as disclosed herein for selectively purifying a lithium chloride product stream from an aqueous lithium salt-containing solution may have a Li:TDS ratio of 0.08, 0.085, 0.09, 0.095, 0.10, 0.105, 0.11, 0.115, 0.12, 0.125, 0.13, 0.135,0.14, 0.145, 0.15, 0.155, 0.16, 0.165, 0.17, 0.175 or 0.18.

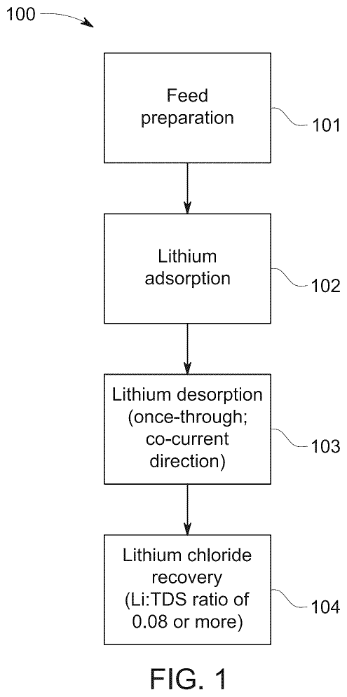

FIG. 1 shows a flow chart of a method of producing lithium chloride according to one aspect of the present disclosure. The process 100 as disclosed herein includes step 101 of feed preparation; step 102 of lithium adsorption in which an aqueous lithium salt-containing solution is introduced at a variable velocity within the range of 4 to 800 LPM/M² column cross sectional area to one or more columns filled with a lithium selective sorbent, such columns being referred to as adsorbent columns or sorbent columns; step 103 of lithium desorption in which lithium is eluted from the one or more columns; and step 104 in which a high-purity lithium chloride product is recovered.

With continued reference to FIG. 1, the feed is an aqueous lithium salt-containing solution and is not limited by the disclosure but may originate from a variety of sources such as any of a geothermal source, oil fields, hard rock lithium mining, mineral digestion, tailings from a lithium mining process, a well application, a clay or sea water. In another embodiment the aqueous lithium salt-containing solution is produced synthetically by extraction from a lithium-containing material and may be, for example, any aqueous recycling solution containing lithium chloride. Examples of lithium-containing materials include clays, black mass from end-of-life battery recycling, off-specification battery materials, recycled battery materials or combinations of these materials; the resulting extractant in these examples comprises acidity and cations. Examples of components of the extractant are hydrochloric acid, sodium chloride, potassium chloride, perchloric acid and chloric acid. The extractant is then pH adjusted to the desired range for a specific sorbent. The aqueous lithium salt-containing solution may therefore be a naturally occurring solution or a synthetic solution, or a combination thereof. The lithium may be considered to be a brine and may be present in the aqueous lithium-containing solution as, for example, lithium chloride.

As indicated by step 101 in FIG. 1, in one embodiment, the process of the present disclosure includes a step of preparing the feed. Step 101 may include pre-treating the aqueous lithium salt-containing solution. For instance, the pre-treatment may be conducted using various means for various reasons. In one embodiment, the pre-treatment may be a mechanical pre-treatment or a temperature adjustment. For instance, the pre-treatment may simply be for the removal of solids within the aqueous lithium-containing solution. The means for removal of such solids is not necessarily limited by the disclosure. For instance, such pre-treatment may include filtration. The filtration may include multi-media depth filtration, membrane micro-filtration, membrane ultra-filtration, as well as other methods generally utilized in the art. In one embodiment, the pre-treatment may be a chemical pre-treatment such as oxidation/reduction chemistry. If necessary, in one embodiment, the pre-treatment may include a pH adjustment. For instance, the pH adjustment may be provided by using a pH adjustment solution. In this regard, the pH adjustment solutions are not necessarily limited by the disclosure and may be one generally utilized in the art for adjusting pH. This pH adjustment solution may, depending on the desired direction of the pH adjustment, include an acid or a base. The pre-treatment may be used to concentrate the aqueous lithium salt-containing solution. Such concentration may be carried out using means generally known in the art, such as, without limitation, evaporation, or reverse osmosis. The pre-treatment may be to remove certain impurities present in the aqueous lithium salt-containing solution, such as those that may affect the purity of the final lithium product. These impurities may include multi-valent ions, such as divalent ions. Such pre-treatment may include a step of neutralization, such as with an alkali or ammonia.

As shown in FIG. 1, lithium adsorption occurs in step 102. There may be one or more columns, each filled with a lithium selective sorbent. This lithium selective sorbent may be any substance that is able to adsorb lithium from the aqueous lithium salt-containing solution. The specific nature of the lithium selective sorbent is not limited by the disclosure but may be any of an ion sieve sorbent, a lithium-metal oxide sorbent, a mixed metal oxide sorbent, an alkali or alkali earth metal/alumina matrix, transition metal/alumina matrix or a molecular sieve sorbent. Layered aluminium double hydroxide chloride sorbents, LiCl·Al₂(OH)₆·nH₂O (Li-LDH) have shown promising application in selective lithium extraction. While lithium loading capacities for these materials are low (0.1-10 mg lithium/g media) compared to other adsorption processes, their high selectivity to lithium and the ability to elute with water make them attractive candidates for commercial applications.

The lithium-selective sorbent can allow for the extraction or recovery of a relatively high amount of lithium from the aqueous lithium-containing solution. For instance, the amount of lithium adsorbed from the aqueous lithium-containing solution may be 20 mol % or more, such as 30 mol % or more, such as 40 mol % or more, such as 50 mol % or more, such as 60 mol % or more, such as 70 mol % or more, such as 80 mol % or more, such as 90 mol % or more, such as 95 mol % or more based on the total amount of lithium present in the aqueous lithium-containing solution. In the present disclosure, the amount of lithium adsorbed from the aqueous lithium-containing solution may be any amount that gives rise to a sorbent with a greater lithium chloride content than the sorbent prior to introducing the aqueous lithium-containing solution. It should be understood that such amount may be based on the total amount of lithium present in the aqueous lithium-containing solution that is provided to the lithium-selective sorbent. In this regard, the aqueous lithium-containing solution containing lithium may be converted to a barren brine. The barren aqueous lithium-containing solution may be returned to the source from which it was originally obtained.

The process as disclosed herein uses columns which may be packed-bed columns, which may alternatively be known as fixed-bed columns. When there are two or more columns, such columns may be arranged in a series arrangement or a parallel arrangement.

The process as disclosed herein requires at least one column. However, there may be any number of columns depending on the size of the arrangement and the volume of aqueous lithium salt-containing solution to be processed. For instance, there may be 2, 3, 4, 5, 6, 7, 8, 9, 10, 11, 12, 13, 14, 15, 16, 17, 18, 19, 20, 21, 22, 23, 24, 25, or 25 to 30 columns, 30 to 35 columns, 35 to 40 columns, 40 to 45 columns, 45 to 50 columns or more than 50 columns in total.

During operation, an aqueous lithium salt-containing solution is loaded into at least one column. The direction of loading may generally be an upward direction or a downward direction. The flow of the aqueous lithium salt-containing solution moves through the one or more columns before exiting the system. As the aqueous lithium salt-containing solution moves through the one or more columns, lithium chloride is adsorbed onto the lithium selective sorbent in the one or more columns and loading continues until the sorbent in the column comprises a greater lithium chloride content than the sorbent prior to introducing the solution.

The speed of loading affects lithium adsorption onto the column. Flowing of the aqueous lithium salt-containing solution at a low speed, for example 40 LPM/M² column cross sectional area, enables optimum adsorption, or loading, of the lithium chloride in the aqueous lithium salt-containing solution onto the sorbent in the column. This is because a low speed (or slow speed) allows for more contact time of the aqueous lithium salt-containing solution with the sorbent, and consequently improved loading of the lithium chloride onto the column. Improved and more uniform loading consequently allows for improved elution and increased separation of the cations other than lithium, allowing for higher purity lithium chloride. However, flowing of the aqueous lithium salt-containing solution at a low speed, for example 40 LPM/M², means that it takes longer for the lithium chloride in the aqueous lithium salt-containing solution to adsorb to the sorbent in the column, which is not commercially viable.

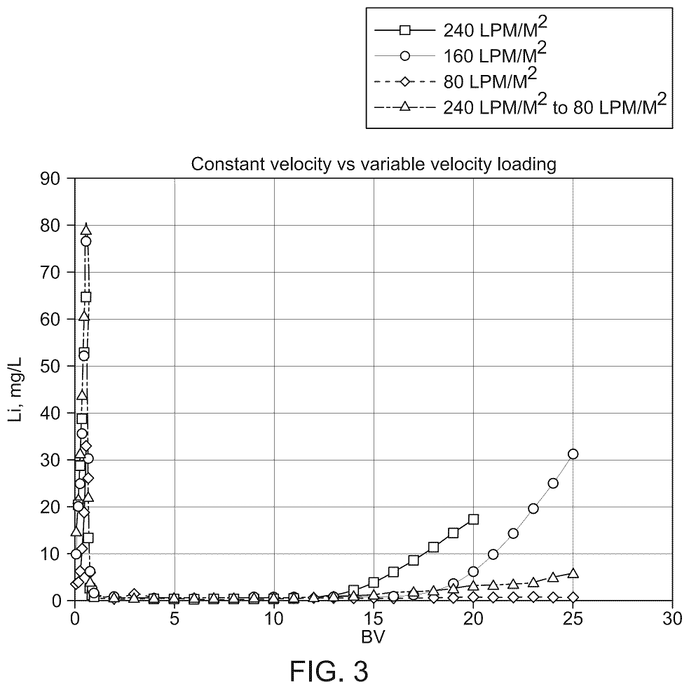

Therefore, in the present disclosure, the flowing of the aqueous lithium salt-containing solution is carried out at a variable velocity. This variable velocity may comprise a period of flowing the aqueous lithium salt-containing solution at a relatively faster rate followed by a period of flowing the aqueous lithium salt-containing solution at a relatively slower rate. As described in Example 2 and illustrated in FIG. 3, flowing of the aqueous lithium salt-containing solution at a rate of 240 LPM/M² is followed by a gradual reduction in the flow rate down to 80 LPM/M². Such a variable flow rate takes advantage of the improved loading at a slow speed as described in the preceding paragraph but also incorporates a period of relatively faster loading to increase the overall efficiency of the loading process of the lithium chloride onto the sorbent in the column. Therefore, flowing of the aqueous lithium salt-containing solution at a variable velocity, namely a relatively faster speed followed by a relatively slower speed, enables more uniform loading of lithium chloride onto the column in the same unit time. This improved loading, or improved adsorption, of the lithium chloride onto the sorbent in the column allows improved elution and increased separation of lithium from the other cations, allowing for a more favourable percentage of lithium to TDS in the product, and consequently higher purity lithium chloride.

Table 2 below shows that a variable flow rate provides the most efficient flow rate, as displayed in the sixth column. Breakthrough is a pre-determined level of lithium between a concentration-outlet to concentration-inlet of 0 to 1 detected in the raffinate.

TABLE 2

| | | | Total | | Efficiency |
|---|---|---|---|---|---|
| | Vol to | Time to | Loading | Min per g | from baseline |
| | Breakthrough | Breakthrough | (g of | lithium | (% relative |
| Flow rate | (bed volumes) | (minutes) | lithium) | (Onstream) | to time) |
| 240 LPM/M² | 14-15 | 149 | 1.1 | 138.7 | 100% |
| 160 LPM/M² | 18-19 | 235 | 1.4 | 172.4 | 80% |
| 80 LPM/M² | Did not occur | 459 | 1.8 | 251.9 | 55% |
| Variable (i.e. | 20-21 | 210 | 1.6 | 128.8 | 108% |
| 240 LPM/M² to | | | | | |
| 80 LPM/M² | | | | | |

Flow rates for the aqueous lithium salt-containing solution will vary depending on equipment set-up, for example, size of the columns. However, typical flow rates are likely to vary within the range of 4 LPM/M² to 800 LPM/M². References to a “relatively slower rate” and a “relatively faster rate” mean in relation to two or more different flow rates within this range. For example, references herein to “flowing the aqueous lithium salt-containing solution at a relatively faster rate followed by a period of flowing the aqueous lithium salt-containing solution at a relatively slower rate” could refer to: flowing the aqueous lithium salt-containing solution at a rate of 800 LPM/M² followed by a gradual reduction in the flow rate down to 600 LPM/M²; flowing the aqueous lithium salt-containing solution at a rate of 600 LPM/M²followed by a gradual reduction in the flow rate down to 400 LPM/M²; flowing the aqueous lithium salt-containing solution at a rate of 400 LPM/M² followed by a gradual reduction in the flow rate down to 200 LPM/M²; flowing the aqueous lithium salt-containing solution at a rate of 320 LPM/M² followed by a gradual reduction in the flow rate down to 160 LPM/M²; or flowing the aqueous lithium salt-containing solution at a rate of 280 LPM/M² followed by a gradual reduction in the flow rate down to 40 LPM/M². However, any alternative combinations of speeds are considered to be within the scope of this disclosure.

Once the lithium has been adsorbed to the lithium-selective sorbent, the adsorbed lithium is desorbed or eluted from the sorbent using various methods, as shown by 103 in FIG. 1. The specific nature of the desorbent fluid is not limited by the disclosure. The eluting may be conducted with a liquid. The liquid utilized may be dictated by the type of lithium-selective sorbent utilized. The liquid may comprise water, pH adjusted water or polar organic solvent.

In one embodiment, the liquid may primarily include water. For instance, the water may be present in an amount of 95 wt. % or more, such as 98 wt. % or more, such as 99 wt. % or more, such as 100 wt. %.

In one embodiment, the liquid may include water in combination with an acid. For instance, the liquid may be a dilute acid (i.e., an acid mixed with water in an amount more than the acid itself). In this regard, in one embodiment, the liquid may include more water than acid on a weight basis. The acid may be hydrochloric acid or sulfuric acid or other suitable acids such as, without limitation, citric acid or carbonic acid. The concentration of acid may be less than 1 M, such as 0.5 M or less, such as 0.2 M or less, such as 0.1 M or less. The acid may have a pH of 1 or more, such as 1.5 or more, such as 2 or more, such as 2.5 or more. The pH may be 4 or less, such as 3.5 or less, such as 3 or less, such as 2.5 or less, such as 2 or less.

The desorbent fluid may be a recycled process stream or may be derived from other process operation, for example a reverse osmosis permeate, an evaporator condensate or an ion exchange regeneration.

As understood, the procedures described herein use water at many steps. For example, water can commonly be used for washing. It is possible, for water to be replaced in whole or in part in any process described herein with air. For example, air can be used to purge a vessel or membrane rather than water.

An average contact time of the adsorbed lithium in the lithium-selective sorbent with the liquid, such as the acid, for eluting may be 10 minutes or less, or 8 minutes or less, or 5 minutes or less, or 4 minutes or less, or 3 minutes or less, or 2 minutes or less, or 1 minute or less.

Eluting at the lowest speed possible gives optimum separation of the cations and therefore increased separation of lithium from other cations. This increased separation allows higher purity lithium to be obtained. However, carrying out the elution process at a low speed for the whole cycle is not commercially viable.

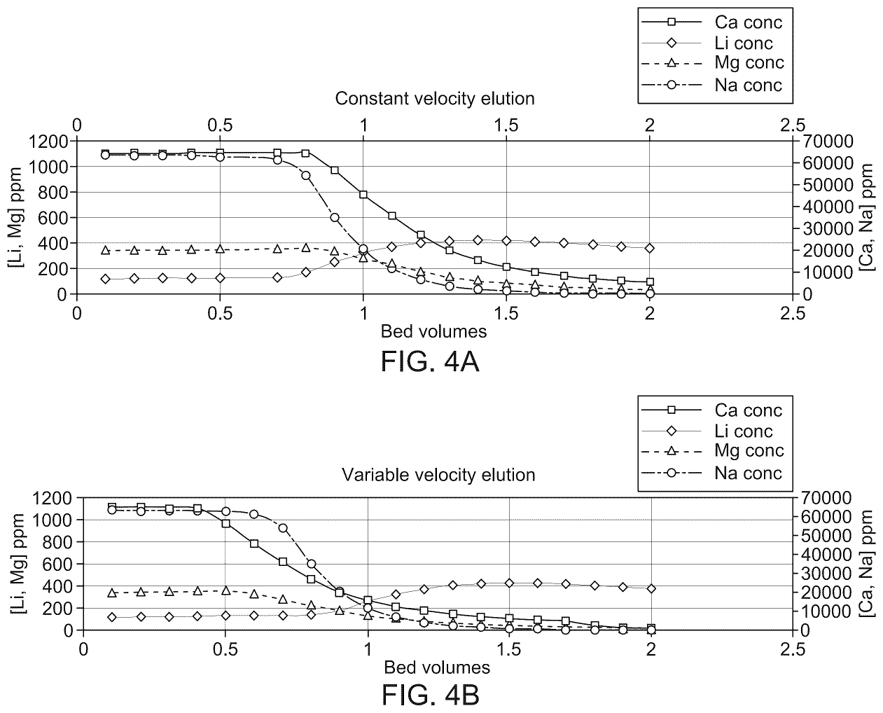

The present disclosure is directed to maximizing the amount of lithium that is eluted from the sorbent whilst minimizing the amount of all other cations. Therefore, in an embodiment and as shown in Example 3 and FIG. 4B, the flowing of the desorbent fluid to enable the elution process may be carried out at a variable velocity. Such variable velocity may be any two or more speeds within the range of 4 LPM/M² to 800 LPM/M². The flowing of the desorbent fluid at a variable velocity can help to achieve an eluate stream with a Li:TDS ratio of 0.08 or more. This variable velocity may comprise a period of flowing the desorbent fluid at a relatively slower rate, followed by a period at a relatively faster rate. References to a “relatively slower rate” and a “relatively faster rate” mean in relation to two or more different flow rates within the 4 LPM/M² to 800 LPM/M² range. For example, references herein to “flowing the desorbent fluid at a relatively slower rate followed by a period of flowing the desorbent fluid at a relatively faster rate” could refer to: flowing the desorbent fluid at a rate of 600 LPM/M² followed by a gradual increase in the flow rate up to 800 LPM/M²; flowing the desorbent fluid at a rate of 400 LPM/M² followed by a gradual increase in the flow rate up to 600 LPM/M²; flowing the desorbent fluid at a rate of 200 LPM/M² followed by a gradual increase in the flow rate up to 400 LPM/M²; flowing the desorbent fluid at a rate of 160 LPM/M² followed by a gradual increase in the flow rate up to 320 LPM/M²; or flowing the desorbent fluid at a rate of 40 LPM/M² followed by a gradual increase in the flow rate up to 280 LPM/M². However, any alternative combinations of speeds are considered to be within the scope of this disclosure.

The variable velocity elution concept helps separate the larger unwanted cations from the smaller lithium cations. At some point during the elution process, the speed of flow of the clean deionized (DI) water wash is reduced, allowing the larger unwanted sodium, calcium and magnesium cations to slowly dilute and drop out more quickly while the smaller lithium cations continue to chemically bond to the sorbent. This aids in the reduction of the overall concentration of these unwanted cations, giving a higher purity lithium during elution. The speed of flow of the clean DI water wash is then increased for the subsequent bed volumes. FIG. 4B shows that lithium is better separated with a variable velocity elution, compared to with a constant velocity elution as shown in FIG. 4A, thereby providing a purer lithium eluate, with a higher Li:TDS ratio. In FIG. 4B, the peak of the lithium in the eluate is clearly seen to the right of all other cations. This gap makes it easier to isolate lithium as the only desired cation later in the elution process. Therefore, increasing the size of the separation between lithium and other unwanted cations (TDS) on an elution profile helps to increase the purity of the lithium in the lithium chloride product stream.

The process of desorption may be either co-current or counter-current with respect to the process of adsorption. For example, the loading step (feedstock in and barren brine out) may occur from, for example, the bottom to the top, and in co-current elution, the elution step (elution water in and lithium product out) also occurs in this same direction. Alternatively, for co-current elution, the loading step (feedstock in and barren brine out) occurs, for example, from the top to the bottom, and the elution step (elution water in and lithium product out) also occurs in this same direction. In counter-current elution, the loading step (feedstock in and barren brine out) may occur from the bottom to the top, and the elution step (elution water in and lithium product out) occurs from the top to the bottom. Alternatively, in counter-current elution, the loading step (feedstock in and barren brine out) occurs from the top to the bottom, and the elution step (elution water in and lithium product out) occurs from the bottom to the top.

The use of co-current elution is more economical than counter-current elution. The capital costs and operating costs are reduced when using co-current elution compared to counter-current elution. For example, fewer valves and pumps are required when running co-current elution.

Further still, operating in co-current mode allows for increased efficiency in the flowing of the volumes of aqueous lithium salt-containing solution and the desorbent fluid because in co-current mode, these volumes can be directed more appropriately within the unit flowsheet. This means that very precise and specific compositions of waste and product are obtained in a fashion that would be un-achievable with counter-current operation, which leads to more wasted volumes than when operating in co-current mode. This leads to further improvements in the final Li:TDS ratio achieved and also ease of downstream processing including but not limited to reverse osmosis concentration and multiple loading and elution steps in series.

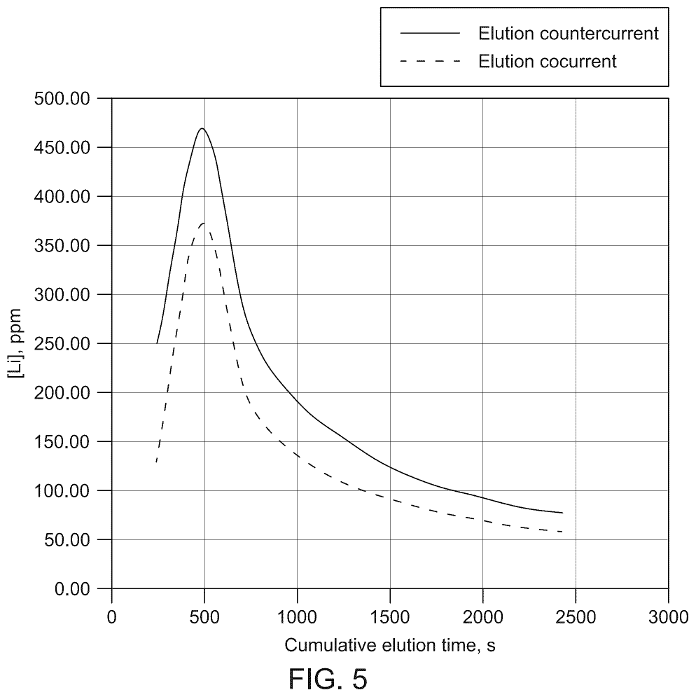

FIG. 5 shows that when the column is loaded in the same way, i.e. same bed volumes of aqueous lithium salt-containing solution, and then eluted with the same bed volumes in either co-or counter-current, more lithium is eluted in the counter-current arrangement. The present disclosure is directed to a process for selectively purifying a lithium chloride product stream from an aqueous lithium salt-containing solution wherein the eluate stream has a Li:TDS ratio of 0.08 or more. Such a ratio can be obtained by using a portion of the eluate stream that has a sub-optimum concentration of lithium (i.e. a portion of the eluate stream which does not have the highest lithium concentration) which concomitantly means that there is also a low level of TDS in the eluate.

The desorbent fluid is flowed once-through the at least one or more columns to desorb lithium chloride from the sorbent into an eluate stream. In contrast to existing systems, there is no recycle or partial recycle of an eluate stream directly back to the sorbent. The flowing of the desorbent fluid once-through at least one or more columns increases the overall efficiency of the process.

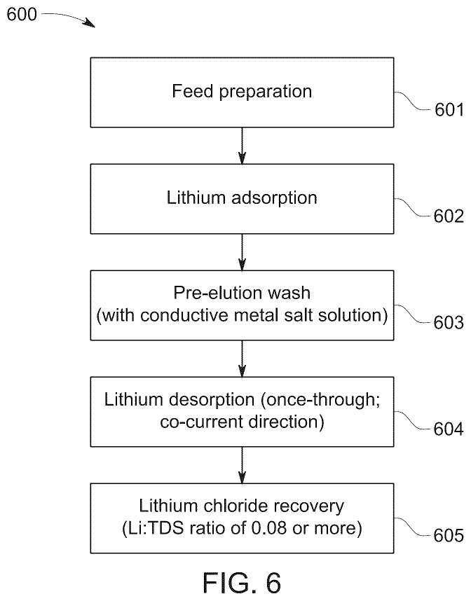

In an embodiment and as shown in FIG. 6, step 603 of using a pre-elution wash with a conductive metal salt solution can help elution. According to the embodiment 600 in FIG. 6, aqueous lithium salt-containing solution is prepared at step 601, which may include pre-treatment steps as described at step 101 in accordance with FIG. 1. Step 601 is followed by step 602 of lithium adsorption. In this illustrated embodiment, step 602 is followed by step 603 of using a pre-elution wash with a conductive metal salt solution. The use of a conductive metal salt solution can help to achieve an eluate stream with a Li:TDS ratio of 0.08 or more. The conductive metal salt solution may be an alkali metal salt solution such as any mono-valent water-soluble salt, for example, sodium chloride or potassium chloride. This use of a conductive metal salt solution at the start of the elution is then followed by deionized water elution and this provides optimum separation of divalent cations from lithium chloride. The concept is that the feedstock remaining in the columns at the end of loading are high in contaminant salts. By using a solution that is lower in concentration as an intermediate wash that is not only lower in contaminants than the feed but high enough in conductivity to prevent immediate elution of the lithium, it is possible to ensure that the wash results in the subsequent elution with DI water to contain less contaminants and thereby gives a higher purity product.

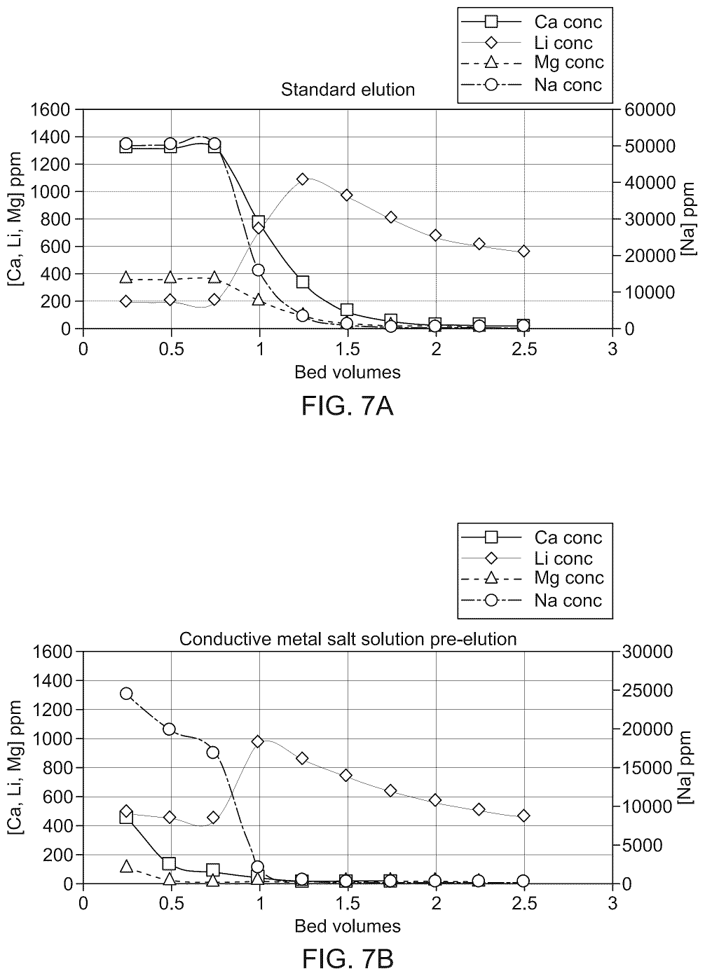

FIG. 7A below shows the separation efficiency of lithium from calcium and magnesium over a standard full elution cycle and FIG. 7B shows the separation efficiency of lithium from calcium and magnesium where a conductive metal salt solution is used prior to the elution cycle. In FIG. 7B, the peak of the lithium in the eluate is clearly seen to the right of all other cations. This gap makes it easier to isolate lithium as the only desired cation later in the elution process. Therefore, increasing the size of the separation between lithium and other unwanted cations (TDS) on an elution profile helps to increase the purity of the lithium in the lithium chloride product stream. In this illustrated embodiment, step 603 is followed by lithium desorption step 604 which is subsequently followed by step 605 of recovery of lithium chloride having a Li:TDS ratio of 0.08 or more.

The deployment of using variable flow velocities of the aqueous lithium salt-containing solution in the loading process and the flowing of the desorbent fluid in the elution process can be coupled with the other processes such as addition of a conductive metal salt solution wash step before desorption of the lithium chloride from the sorbent in the column. In combination, these approaches help to increase the separation of larger salts from lithium on the elution profile, leading to a higher purity lithium in a product stream.

In an embodiment, after recovery of the fraction of the eluate having a Li:TDS ratio of 0.08 or more, a further step of concentrating the lithium chloride product stream using any of reverse osmosis, solvent extraction, evaporation, ion exchange or a combination of these may be deployed. The reverse osmosis may be any of seawater reverse osmosis, osmotically assisted reverse osmosis or ultra-high pressure reverse osmosis. Following this further step of concentrating the lithium chloride product stream using reverse osmosis, solvent extraction, evaporation, ion exchange or a combination of these processes, the process according to the present disclosure may be repeated. In an embodiment, the process of direct lithium extraction in a first column is followed by a softening step which may be ion exchange or chemical softening or any relevant known process in the art and then there is a subsequent process of direct lithium extraction in a second column. Optionally, after repeating the steps of the present disclosure, a yet further step of concentrating the lithium chloride product stream using reverse osmosis, solvent extraction, evaporation, ion exchange or a combination of these may be deployed. In this configuration, a first stage “rough cut” separation in a first direct lithium extraction column is deployed to achieve a low TDS eluate. The next step in the process is to use reverse osmosis or seawater reverse osmosis concentration to increase the lithium concentration and reduce the volume of the process stream. This is followed by a second, “polishing” stage in a second direct lithium extraction column, further increasing the Li:TDS ratio, and further concentration of the lithium chloride product.

This multistep purification and concentration has several advantages. One advantage is the level of purity as measured by a Li:TDS ratio of 0.15 or greater, which can be achieved. This is significantly purer than other comparable configurations. Another advantage of this approach is that the seawater reverse osmosis permeates 60-75% of the boron in that concentration step. This removes 60-75% of the boron from the product stream which would otherwise need to be removed with ion exchange or precipitation methods. Another advantage of this improvement is the low sodium in the final eluate which allows for Strong Acid Cation (SAC) resin to be used for softening, the process of removing divalent cations and replacing them with monovalent sodium cations. Softening with SAC resin allows regeneration of the ion exchange resin with NaCl solution which is safer and less costly than using mineral acids to regenerate Weak Acid Cation (WAC) or chelating resin.

Further still, the multistep purification and concentration allows the flowsheet to move directly from the direct lithium extraction process to the carbonation process, which has additional advantages in reducing the complexity of the downstream process steps of producing battery-grade lithium carbonate, thereby lowering operating and capital costs.

The processes of the disclosure will now be more particularly described with reference to the following non-limiting Examples.

### EXAMPLES

The following non-limiting Examples are provided to illustrate various aspects of the invention.

### Example 1 (Comparative)

### Standard Loading

In the experimental setup detailed in the examples, columns measuring 1 inch in diameter and 4 feet in height were employed, packed with freshly prepared adsorbent material. The adsorption material was subject to conditioning by passing 15 bed volumes (equivalent to 7500 mL) of brine solution (comprising approximately 100000 ppm NaCl, 25000 ppm CaCl₂, 2500 ppm MgCl₂ and 500 ppm LiCl) through the column at a controlled flow rate of 266 LPM/M². Subsequently, the column underwent a thorough rinsing with 10 bed volumes of ultra-clean deionized (DI) water, maintaining the same flow rate.

Each bed within the column possessed an estimated volume of 500 mL, thereby deeming every 500 mL of solution passing through as one bed volume. The complete procedure of running 15 bed volumes of brine followed by 10 bed volumes of DI water constitutes a single cycle, with column conditioning typically requiring 5 cycles.

Post-conditioning, the column's loading capacity was evaluated by passing the pre-prepared brine solution, mirroring the earlier described concentration, through the column at the same rate and under ambient conditions. Samples of the effluent, or raffinate, were intermittently extracted and subjected to analysis via Inductively Coupled Plasma Optical Emission Spectroscopy (ICP-OES) to quantify the concentrations of pertinent cations such as lithium and calcium, among others.

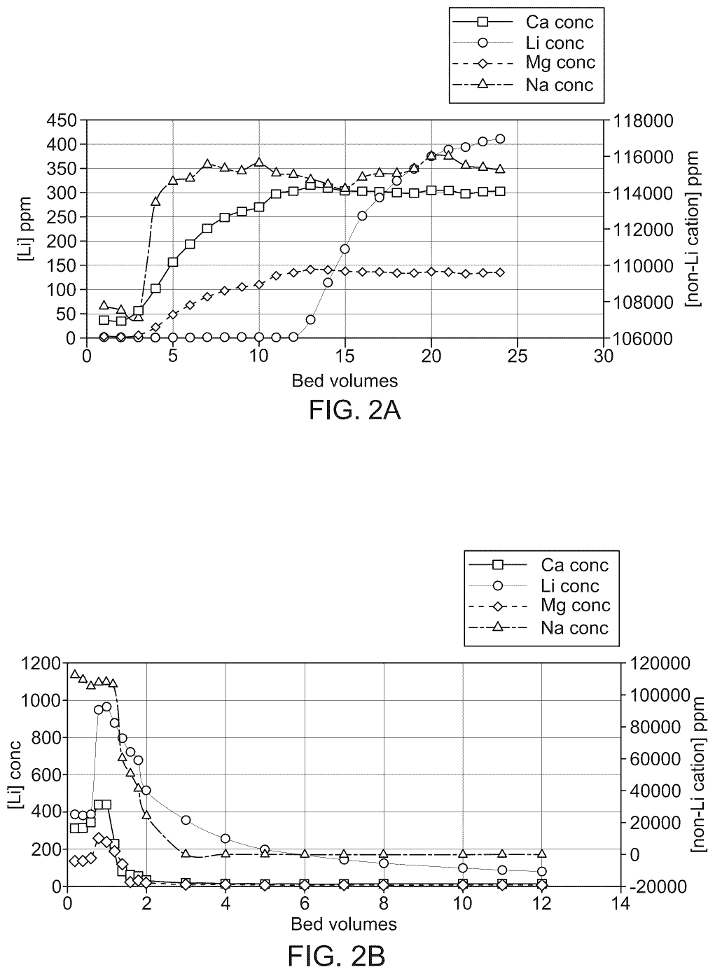

A representative loading profile, illustrating the progression of the adsorption process, is depicted in FIG. 2A for reference and visualization.

### Standard Elution and Testing

Once the sorbent has reached its maximum capacity for lithium adsorption, the column proceeds to the subsequent phase of the cycle known as elution or desorption. The sorbent is deemed fully loaded as the sampled concentration nears parity with the lithium concentration in the brine feed.

A standard elution process is initiated by circulating clean deionized (DI) water over the sorbent, either in the same direction (co-current) or in the opposite direction (counter-current) to the loading brine cycle, maintaining the same flow rate (266 LPM/M²) at room temperature. As the DI water traverses the sorbent, the concentrations of the three larger cations—sodium (Na), calcium (Ca), and magnesium (Mg)—become diluted, leading to a reduction in their concentrations.

Initially, the smaller lithium cations remain bound to the sorbent. However, as the concentrations of the larger cations approach a terminal level, the release of lithium cations commences. A typical elution cycle graph, portraying the dynamics of this process, is presented in FIG. 2B for reference. An exemplar run may exhibit a progression akin to the graph illustrated in FIG. 2B.

### Example 2: Variable Velocity Loading

By implementing a strategy of varying linear velocity during the loading cycle, there is a notable enhancement in the column's efficiency, resulting in improved lithium loading and optimized capacity utilization over time. Alternating between relatively faster and slower flow rates facilitates the most effective utilization of capacity per unit time. In this specific scenario, the aqueous lithium salt-containing solution is initially flowed at a rate of 240 LPM/M², followed by a gradual reduction to 80 LPM/M².

FIG. 3 depicts the lithium concentration levels on the sorbent under three constant velocity conditions (80 LPM/M², 160 LPM/M² and 240 LPM/M²), alongside the concentration achieved by employing a variable velocity approach (240 LPM/M² followed by a gradual reduction to 80 LPM/M²).

Utilizing such a variable velocity approach enables more uniform loading of lithium chloride onto the column in the same unit time. This improved loading, or improved adsorption, of the lithium chloride onto the sorbent in the column allows improved elution and increased separation of lithium from the other cations, allowing for a more favourable percentage of lithium to TDS in the product, and consequently higher purity lithium chloride. This strategy effectively optimizes the utilization of the column's capacity while enhancing the efficiency of lithium extraction processes.

### Example 3: Variable Velocity Elution

Example 3 demonstrates that employing slower elution rates for a period of time yields superior separation of lithium from other cations, resulting in a purer lithium eluate with a higher Lithium to Total Dissolved Solids (TDS) ratio as compared to employing a non-variable elution rate throughout.

The variable velocity approach introduced in Example 2 for loading operations also applies to lithium elution, albeit in reverse. The fundamental principle involves initiating the elution process at a relatively slower rate to facilitate effective separation between lithium and other cations, followed by a relatively faster rate to expedite lithium removal from the column.

This variable velocity elution strategy aids in the segregation of larger unwanted cations from the smaller lithium ions. In Example 3, during the initial elution phase encompassing the first two bed volumes, the flow rate of the clean DI water wash was deliberately reduced. This deliberate deceleration allowed the larger undesirable cations such as sodium (Na), calcium (Ca), and magnesium (Mg) to undergo gradual dilution and swift separation from the sorbent, while the smaller lithium ions continued to remain chemically bound to the sorbent. This initial separation of larger cations facilitates a significant reduction in the overall concentration of unwanted salts, resulting in a lithium eluate of higher purity.

Subsequently, the elution process for the remaining bed volumes was accelerated. The graphs depicted in FIG. 4A and FIG. 4B compare constant velocity elution (FIG. 4A) with variable velocity elution (FIG. 4B). Constant velocity elution denotes a flow rate of 266 LPM/M² while variable velocity elution indicates a flow rate of 132 LPM/M² for 3 bed volumes followed by an increase to a flow rate of 266 LPM/M² for the remainder of the elution.

In the variable velocity elution, slowing down the elution rate for the initial phase shifts the lithium elution to the right of the graph just adequately to obtain a more concentrated lithium solution. The variable velocity elution thus effectively segregates larger cations to the left and lithium ions to the right, creating a discernible gap. This strategic separation aids in isolating lithium ions as the sole desired cations during subsequent stages of the elution process.

Consequently, widening the separation between lithium and other unwanted cations (TDS) on an elution profile substantially enhances the purity of lithium in the resulting lithium chloride product stream.

### Example 4: Co-Current Versus Counter Current Elution

Two elution profiles were conducted, one with elution occurring co-currently to loading, and the other with elution performed counter currently to loading, utilizing the same adsorbent packed column bed. Beds were both stripped between elutions to ensure lithium not carried forward from one test into next test. Both elution profiles utilized identical feed brine with excess brine loading to ensure consistent media saturation, thereby avoiding any errors stemming from the creation and mixing of feedstock from scratch. Pre-elutions were conducted for both profiles to ensure the absence of occupied lithium adsorption sites within the column, thereby preventing any skewing of test results prior to commencement. The bed's differential pressure was observed to be consistently high across both profiles.

During the 25 bed volume on-stream loading phase, both beds were loaded to similar values (approximately 0.96 g lithium for countercurrent loading and approximately 1.05 g lithium for co-current loading). This agreement in loading suggests the validity of comparing the profiles, given the constant feedstock condition and bed capacity prior to loading.

In countercurrent elution, the loading step (inlet feedstock and outlet barren brine) occurred from bottom to top, while the elution step (inlet elution water and outlet lithium LSS product) occurred from top to bottom. Conversely, for co-current elution, both the loading and elution steps occurred from bottom to top. Operating co-currently allows for savings on one of the two flow distributors, offering a capital cost advantage in vessel design.

When the column is loaded similarly in both arrangements, i.e., with the same bed volumes of lithium feed and subsequently eluted with the same bed volumes either co-currently or counter currently, the net elution in countercurrent mode yields approximately 1.0 g of Li, whereas the net elution in co-current mode yields approximately 0.72 g of Li. The elutions were of equal volume.

While the graph in FIG. 5 illustrates that more lithium is eluted in the countercurrent arrangement, it also indicates that this eluate contains higher levels of Total Dissolved Solids (TDS) compared to the eluate from the co-current arrangement, rendering it less pure. Conversely, the lower concentration of lithium eluted in the co-current arrangement results in a lower concentration of TDS. As detailed in Table 1, the current proposition thus prioritizes the rejection and lower concentration of TDS over obtaining a high concentration of lithium in the eluate. This approach enhances the effectiveness of downstream reverse osmosis processes, ultimately yielding a high concentration of lithium chloride in the final product.

### Example 5: Conductive Metal Salt Solution Pre-Elution

Example 5 delineates an enhancement in lithium separation through the utilization of a conductive metal salt solution as a pre-elution step, resulting in a purer lithium eluate with a higher lithium to Total Dissolved Solids (TDS) ratio.

Loading was executed following the methodology outlined in Comparative Example 1. Upon completion of loading, conventional practice dictates the initiation of the elution process, as described in Comparative Example 1. Typically, elution involves the passage of clean deionized (DI) water over the sorbent at a constant rate of 266 LPM/M² and at room temperature, as shown in FIG. 7A. However, the introduction of a pre-elution wash involving a conductive metal salt solution, such as sodium chloride (NaCl), followed by water elution, has demonstrated improved separation of monovalent lithium (Li) from divalent cations such as calcium (Ca) and magnesium (Mg). This is shown in FIG. 7B.

In Example 5, a pre-loaded column containing approximately 600 mg of lithium was initially eluted with 2 liters of a 2 wt % sodium chloride (NaCl) solution. Subsequently, pure deionized (DI) water was pumped over the sorbent in the same direction as the loading brine and wash, maintaining the same rate 266 LPM/M² and temperature. This approach resulted in the retention of lithium on the sorbent, while the NaCl solution progressively diluted and eliminated all Ca and Mg cations, leaving only Na to undergo separation during elution.

FIG. 7B illustrates the efficacy of lithium separation from calcium and magnesium, highlighting the rapid transition of lithium chloride increase alongside the decrease of calcium, magnesium, and sodium when the 2 wt % sodium chloride solution was used. The peak of lithium in the eluate is distinctly observed to the right of all other cations.

Comparatively, FIG. 2B, representing the use of pure DI water for elution, and also FIG. 7A, demonstrates poorer separation of divalent cations from lithium. The lithium peak in the eluate overlaps with calcium in FIG. 2B and FIG. 7A, whereas in inventive Example 5, as depicted in FIG. 7B, the lithium peak is clearly separated from the calcium peak.

1. A process for selectively purifying a lithium chloride product stream from an aqueous lithium salt-containing solution, the process comprising the steps of:
a. introducing the aqueous lithium salt-containing solution to one or more columns filled with a lithium selective sorbent;
b. flowing the aqueous lithium salt-containing solution through the one or more columns to adsorb lithium chloride from the aqueous lithium salt-containing solution onto a sorbent and form a sorbent with a greater lithium chloride content than the sorbent prior to introducing the solution;
c. flowing a desorbent fluid once-through the at least one or more columns to desorb lithium chloride from the sorbent into an eluate stream, wherein the desorbent fluid is flowed in a co-current direction with respect to the direction of flow of the aqueous lithium salt-containing solution, and
d. recovering a lithium chloride product stream from the eluate stream, wherein the eluate stream has a Li:TDS ratio of 0.08 or more.

2. The process of claim 1, wherein the aqueous lithium salt-containing solution is a naturally-occurring solution, a synthetic solution or a mixture thereof.

3. The process of claim 1, wherein the aqueous lithium salt-containing solution is subject to a pre-treatment step of mechanical pre-treatment, temperature adjustment, chemical pre-treatment or pH adjustment.

4. The process of claim 1, wherein the lithium selective sorbent is an ion sieve sorbent, a lithium-metal oxide sorbent, a mixed metal oxide sorbent, an alkali or alkali earth metal/alumina matrix, transition metal/alumina matrix or a molecular sieve sorbent.

5. The process of claim 1, wherein the one or more columns are packed-bed columns.

6. The process of claim 1, wherein the desorbent fluid is water, pH adjusted water or a polar organic solvent.

7. The process of claim 1, wherein the desorbent fluid is derived from a process operation or is a recycled process stream.

8. The process of claim 1, further comprising a step between step b) and step c) of addition of a conductive metal salt solution.

9. The process of claim 8, wherein the conductive metal salt solution is an alkali metal salt solution.

10. The process of claim 9, wherein the alkali metal salt solution is any mono-valent water-soluble salt.

11. The process of claim 1, further comprising a step e) of concentrating the lithium chloride product stream using reverse osmosis, solvent extraction, evaporation, ion exchange or a combination.

12. The process of claim 11, wherein the reverse osmosis is any of seawater reverse osmosis, osmotically assisted reverse osmosis or ultra-high pressure reverse osmosis.

13. The process of claim 11, further comprising repeating steps a) to e).

14. The process of claim 1, wherein the step of flowing the aqueous lithium salt-containing solution through the one or more columns at a variable velocity is performed within the range of 4 to 800 LPM/M² column cross sectional area.

15. The process of claim 14, wherein the range is 80 to 400 LPM/M² column cross sectional area.

16. The process claim 1, wherein the flowing of the desorbent fluid in step c) is carried out at a variable velocity within the range of 4 to 800 LPM/M² column cross sectional area.

17. The process of claim 16, wherein the range is 80 to 400 LPM/M² column cross sectional area.
